(19) United States
(12) Patent Application Publication
(10) Pub. No.: US 2022/0067690 A1
(43) Pub. Date: Mar. 3, 2022

(54) PEER-TO-PEER DIGITAL TRANSACTION DETAIL ERROR REDUCTION

(71) Applicant: PayPal, Inc., San Jose, CA (US)

(72) Inventor: Rahul Nair, Austin, TX (US)

(21) Appl. No.: 17/003,337

(22) Filed: Aug. 26, 2020

(51) Int. Cl. G06Q 20/22; G06F 16/23; G06Q 20/40; H04L 29/08; H04N 7/14

(52) U.S. Cl. CPC G06Q 20/223; G06F 16/2379; H04N 7/141; H04L 67/104; G06Q 20/40

(57) ABSTRACT

Systems and methods for reducing transaction detail errors in peer-to-peer transactions are disclosed. In one embodiment, a system may receive, from a first device, a peer-to-peer transaction request that includes a user identifier. Based on the user identifier, the system may cause a recipient account details request to display in a user interface of a peer-to-peer transaction application installed on a second device associated with the recipient account. The recipient may complete the recipient account detail request and send a response including the recipient account details to the system. The system may send to the first device a confirmation of the recipient account details received from the second device and a request for an authorization to complete the peer-to-peer transaction request. The system may receive authorization and transfer (or cause to be transferred) funds from the sender account to the recipient account.

### TECHNICAL FIELD

The present disclosure generally relates to digital transactions and more particularly to peer-to-peer digital transaction detail error reduction according to various embodiments.

### BACKGROUND

Peer-to-peer transactions involve digital transfers made from one person to another person. For example, in cross-border remittances, a sender may be required to enter transaction details such as a recipient's bank account number and routing number to carry out the cross-border remittance in accordance with rules and regulations applicable to each of the countries in which the sender and recipient reside. When the sender enters information for the recipient, the sender is susceptible to user input error, which may lead to a delayed or failed transaction. If the transaction is delayed or fails, computer resources, such as those related to processing and storage used in the transaction, may be inefficiently used. Thus, there is a need for an improvement in the field of peer-to-peer digital transaction to simplify the user experience for the sender and reduce the likelihood of failed transactions due to user input error, so that computer resources used in such transactions may be put to an efficient use.

### BRIEF DESCRIPTION OF THE FIGURES

FIG. 1 illustrates is a flow diagram of a process for reducing transaction detail errors in peer-to-peer transactions in accordance with one or more embodiments of the present disclosure.

FIG. 2 illustrates is a flow sequence of a peer-to-peer transaction in accordance with one or more embodiments of the present disclosure.

FIG. 3 illustrates is a flow sequence of a peer-to-peer transaction in accordance with one or more embodiments of the present disclosure.

FIG. 4 illustrates is a flow diagram of a process for reducing transaction detail errors in peer-to-peer transactions in accordance with one or more embodiments of the present disclosure.

FIG. 5 illustrates is a flow sequence of a peer-to-peer transaction in accordance with one or more embodiments of the present disclosure.

FIG. 6 illustrates is a flow diagram of a process for reducing transaction detail errors in peer-to-peer transactions in accordance with one or more embodiments of the present disclosure.

FIG. 7 illustrates is a diagram of a process for reducing transaction detail errors in peer-to-peer transactions by capturing recipient account details during a video call in accordance with one or more embodiments of the present disclosure.

FIG. 8 illustrates a flow diagram for implementing the processes of FIGS. 1, 4, and 6 into operation of a peer-to-peer transaction system in accordance with one or more embodiments of the present disclosure.

FIG. 9 illustrates a block diagram of a networked system suitable for implementing one or more embodiments of the present disclosure.

FIG. 10 illustrates a block diagram of a computer system in accordance with one or more embodiments of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more embodiments. In one or more instances, structures and components are shown in block diagram form in order to avoid obscuring the concepts of the subject technology. One or more embodiments of the subject disclosure are illustrated by and/or described in connection with one or more figures and are set forth in the claims.

The present disclosure describes systems and methods for peer-to-peer digital transaction detail error identification and reduction. Oftentimes, during peer-to-peer transactions, a sender may be required to manually enter transaction details such as a recipient's bank account number and routing number to carry out the peer-to-peer transaction in such a way that funds can be transferred directly to the recipient's bank account in accordance with legal rules and regulations applicable to the countries in which the sender and/or the recipient reside. When the sender enters information corresponding to the recipient, the sender is prone to user input error, which can lead to a failed transaction. For example, there may be user input error where the sender may unintentionally transpose digits in a bank account number corresponding to the recipient as the sender may not be as familiar with the bank account number as the recipient. As another example, there may be user input error where the sender may have been given the wrong bank account number for the recipient and has entered the wrong bank account number. An error in the peer-to-peer transaction from incorrect recipient account details entered by the sender may cause a delay in the peer-to-peer transaction, a blockage of the peer-to-peer transaction, or a peer-to-peer transaction amount to be sent to the wrong recipient in some cases.

The present disclosure provides an improvement in the technical field of peer-to-peer digital transactions by simplifying the user experience for the sender, providing a convenient and user-friendly user interface for a recipient, and reducing the likelihood of delayed or failed transactions due to user input error, which results in a reduction in use of computing resources to address or fix problems caused by user input error. Furthermore, as there may be less delayed or failed transactions, service provider servers may have more bandwidth commensurate with a decrease in the number of delayed or failed transaction due to user input error. In one embodiment of the present disclosure, a peer-to-peer transaction system receives, from a sender device, a peer-to-peer transaction request associated with a sender account. The peer-to-peer transaction request may include a user identifier entered in a user interface by the sender, where the user identifier may be, for example, an email address, phone number, or social media handle that corresponds to the recipient. The system may compare the received user identifier to user identifiers in an accessible account database to determine that the user identifier matches a particular user account corresponding to the recipient.

In response to determining that the user identifier matches a recipient account in the database, the system may cause a recipient account details request to display in a user interface of a peer-to-peer transaction application installed on the recipient's device. In some instances, where the recipient account is logged into the peer-to-peer transaction application installed on the recipient's device and notifications are enabled, the system may send a pop-up notification to the recipient's device for the recipient account details request. For example, the pop-up notification may be a notification that appears on a lock screen of the recipient's device, in a notification center of the recipient's device or peer-to-peer transaction application, or in a minimally invasive banner at a side (e.g., top, bottom, lateral side) of the screen of the recipient's device. As further discussed herein, the recipient may respond by manually entering the requested information in the recipient account details request, capturing an image or video of the requested information on, for example, a check, or by completing an authentication challenge to automatically have the requested information populated and sent to the system. In some embodiments, the recipient account detail information may include contact information (e.g., name, address, and so forth), a bank account number, a routing number, an international bank account number (IBAN), and/or a physical location where funds can be picked up.

Once the recipient has responded to the recipient account details request, the recipient's device may send the recipient accounts detail information to the system. After receiving the recipient account detail information, the system may send to the sender's device a confirmation of the recipient account details received from the recipient's device and a request for an authorization to complete the peer-to-peer transaction request. By sending to the sender's device the confirmation of the recipient account details received from the recipient's device, the sender may be provided with an opportunity to review the transaction and decide whether to authorize continuation and completion of the peer-to-peer transaction. In one embodiment, the confirmation may include a name that was entered by the recipient in the recipient account details request so that the sender may review the name to make sure that it matches the person to whom the sender intends to make the peer-to-peer transfer.

The sender may authorize the completion of the peer-to-peer transaction request, and in response to receiving the authorization to complete the peer-to-peer transaction request, the system may transfer funds from the sender account to the recipient account. Thus, by having the recipient enter the recipient account details rather than the sender, incorrect recipient account details are less likely to be inputted in error as the recipient is more familiar with his/her own recipient account details. Reducing the likelihood of errors caused by incorrectly inputting recipient account details improves the technical field of peer-to-peer transactions by reducing delays in peer-to-peer transactions due to incorrect recipient account details such as when the peer-to-peer transaction cannot move forward until the recipient account details are corrected but the sender does not have the correct recipient account details on hand. The present disclosure further improves the technical field of peer-to-peer transactions by simplifying the user experience for senders so that only knowledge of a user identifier such as an email address, phone number, or social media handle may be required to complete a peer-to-peer transaction with a recipient. In other words, the sender may be able to perform a peer-to-peer transaction regardless of knowledge of the recipient's sensitive information such as bank account information and routing number information. In this regard, the present disclosure further improves the technical field of peer-to-peer transactions by providing a more secure environment for recipients in peer-to-peer transactions where they may only have to share their user identifier with a sender rather than bank account information or other sensitive information to complete a peer-to-peer transaction with the sender. The more secure environment may be advantageous in cross-border peer-to-peer transactions where, traditionally, a recipient would have to share bank account information with the sender, leaving the recipient vulnerable to being hacked if his/her sensitive information is stolen or leaked.

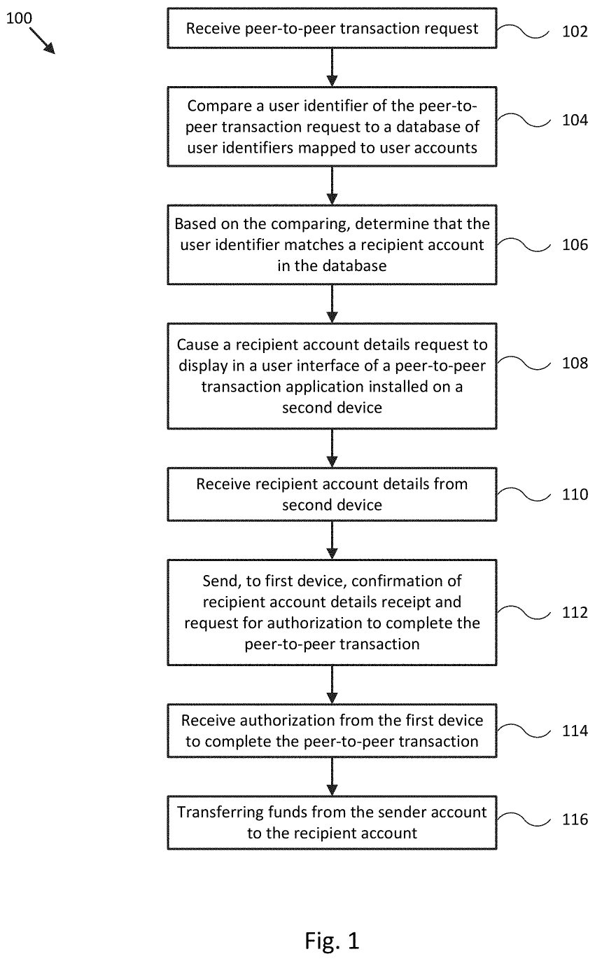

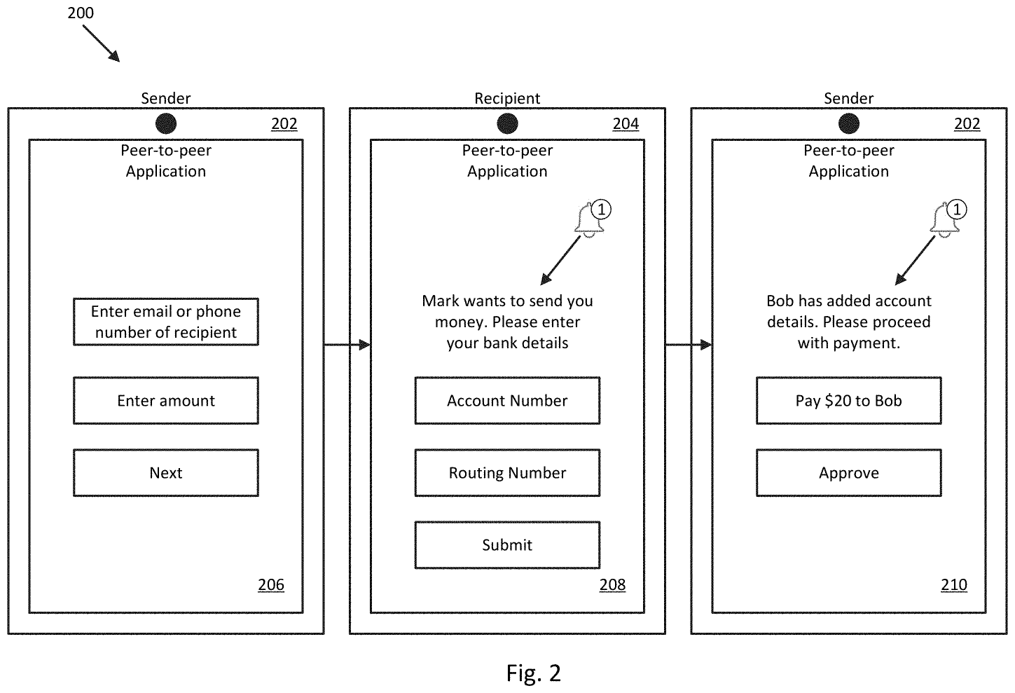

Referring now to FIG. 1, illustrated is a flow diagram of a process 100 for peer-to-peer transactions in accordance with one or more embodiments of the present disclosure. For explanatory purposes, process 100 is primarily described herein with reference to FIGS. 2-5; however, process 100 is not limited to FIGS. 2-5 and may generally be applied to the additional figures of the present disclosure. The blocks of process 100 are described herein as occurring in serial, or linearly (e.g., one after another). However, multiple blocks of process 100 may occur in parallel. In addition, the blocks of process 100 need not be performed in the order shown and/or one or more of the blocks of process 100 need not be performed.

At block 102, a peer-to-peer transaction system may receive, from a first device 202, a peer-to-peer transaction request associated with a sender account. The peer-to-peer transaction request may include a user identifier that has been entered by a sender in a user interface of a peer-to-peer transaction application installed on the first device. For example, as shown in a flow sequence 200 of FIG. 2 (which will be discussed in more detail below), the sender may be presented with a prompt screen 206 on a first device 202 that asks the sender to enter a user identifier such as an email address or phone number associated with the recipient. Other user identifiers such as social media handles or a handle specific to the peer-to-peer transaction application may be used in some embodiments. The prompt screen 206 may further ask the sender to enter a transaction amount for the peer-to-peer transaction, which may be an amount in funds that the sender would like to transfer to the recipient (e.g., directly transfer from the sender's bank account to the recipient's bank account such as through wire transfer). When the sender presses “Next” or a similar submission button, the first device 202 may send the peer-to-peer transaction request to the system (e.g., via a network communication).

Referring back to FIG. 1, at block 104, the system may compare the user identifier included in the received peer-to-peer transaction request to a database of user identifiers mapped to user accounts registered and/or stored to the database associated with and accessible by the system. In one embodiment, the comparing may include the system querying the database for the user identifier to determine the corresponding account. At block 106 the system may determine, based on the comparing, that the user identifier matches a recipient account registered and/or stored to the database.

At block 108, in response to determining that the user identifier matches the recipient account registered and/or stored to the database, the system may cause a recipient account details request to display in a user interface of a peer-to-peer transaction application installed on a second device associated with the recipient account. For example, the recipient account may be logged into the peer-to-peer transaction application installed on the second device, and as shown in FIG. 2, the system may push a notification to the peer-to-peer transaction application to display a prompt screen 208 that notifies the recipient that a sender would like to transfer digital funds to the recipient account via the peer-to-peer transaction application. In some cases, the prompt screen 208 may be a pop-up notification associated with the peer-to-peer application that allows quick access to fill out the recipient account details, for example, in a lock screen, home screen, and/or notification center of a second device 204. In other cases, the prompt screen 208 may be displayed during the next time that the recipient opens the peer-to-peer transaction application on the second device 204. The prompt screen 208 may ask the recipient to enter account details that facilitate completing the peer-to-peer transaction. For example, as shown in FIG. 2, the prompt screen 208 may ask the recipient to enter an account number (e.g., a bank account number) and a routing number. Once the recipient has entered the requested information and pressed “Submit” or a similar button, the second device 204 may send the account information to the system (e.g., via a network communication).

In some embodiments, where the system determines that the user identifier does not match a recipient account in the database, the system may send the recipient account details request to the user identifier through a communication channel associated with the user identifier. For example, the user identifier may be an email address, phone number, or social media handle, and the system may send the recipient account details request to the email address through an email gateway, the phone number through an SMS gateway, or through a social media messaging platform to the social media handle. The recipient account details request may include a hyperlink that when executed/pressed may open a peer-to-peer transaction web client (e.g., a web browser) of the second device 204, where the web client is in communication with a web application of the system. Through the peer-to-peer transaction web client, the recipient may input his/her account details in a user interface having a prompt screen similar to prompt screen 209 shown in FIG. 2. For example, the prompt screen in the web client may ask the recipient to enter account details such as a bank account number and routing number to facilitate completing the peer-to-peer transaction. The recipient may enter the requested information and press “Submit” or a similar button, and the web client on the second device 204 may send the account information to the system through the web application.

In some embodiments, the system may determine that although the user identifier matches a recipient account in the database, the second device 204 does not currently have the peer-to-peer application installed on the second device. If the system determines that the second device 204 does not currently have the peer-to-peer application currently installed, the system may send the recipient account details request to the user identifier through a communication channel associated with the user identifier as discussed above and may include an additional link that, when activated, directs the second device 204 to a download and install process for the peer-to-peer application (e.g., an application store link for the second device 204 to download and install the peer-to-peer application).

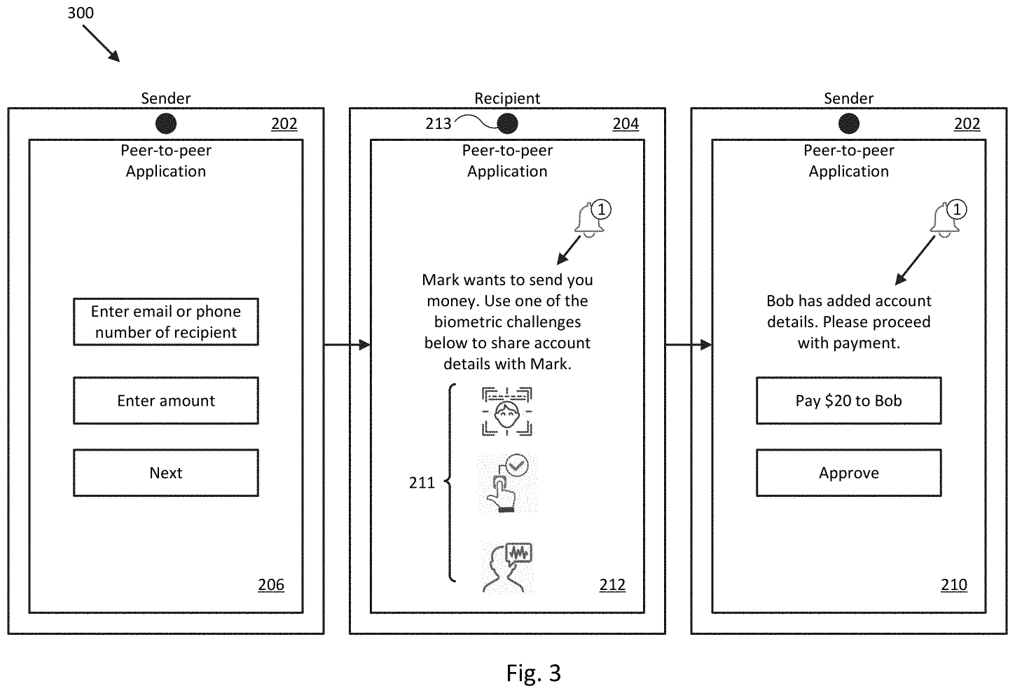

FIG. 3 shows a flow sequence 300 of a peer-to-peer transaction according to one or more other embodiments. The recipient may have his/her account details automatically populated in text fields of the recipient account details request and sent to the system after the recipient completes one or more authentication challenges 211. In the embodiment shown in FIG. 3, the system may send an authentication request to the peer-to-peer transaction application installed on the second device 204, which may require the recipient to complete one or more authentication challenges 211. For example, the authentication challenges 211 may include biometric authentication challenges such as facial recognition, finger scanning, and voice recognition as shown in prompt screen 212 of FIG. 3. The system may instruct the second device 204 to perform a facial scan using a camera 213 of the second device 204, a finger scan using a finger scanner of the second device 204, and/or a voice sample capture using a microphone of the second device 204 to complete the authentication challenge. In some embodiments, the recipient may have options to choose from when completing the biometric authentication challenge such as which authentication challenge he/she would like to complete. In other embodiments, the system may determine which authentication challenge 211 to execute based on available information to the system to verify the identity of the recipient. For example, the system may have stored in a database a facial recognition, finger scan, or voice sample key to which it may compare to the received biometric data from the second device 204 during the authentication challenge. In further embodiments, the sender may dictate which authentication challenge 211 that is required to be completed by the recipient. For example, the sender may request that the recipient complete a facial recognition, finger scan, voice sample, or a combination thereof as part of the authentication challenge to respond to the recipient account details request.

In one embodiment, the sender may include a security question to be answered by the recipient as an authentication challenge. For example, in the peer-to-peer transaction request, the sender may input a security question such as “what is the name of the city that [the sender] grew up in as a child?” and the security question may be asked as an authentication challenge for the recipient to answer in responding to the recipient authentication request. As an illustrative example, a daughter in the United States may want to perform a peer-to-peer transaction with her mother who resides in India. The daughter may include a security question of “what is the name of the city that [the daughter] grew up in as a child?” in the peer-to-peer transaction request, which the system may incorporate into the recipient account details request as an authentication challenge for the mother. Since the mother knows where her daughter grew up, she may easily answer the question to authenticate herself and respond to the recipient account details request. By including a security question, the peer-to-peer transaction may be more secure as the likelihood that a hacker knows the answer to the security question may be less likely than someone who the sender intends to read the security question.

Referring back to FIG. 1, at block 110, the system may receive the account details from the second device 204. At block 112, in response to receiving the account details from the second device 204, the system may send, to the first device 202, a confirmation of the recipient account details received from the second device and a request for an authorization to complete the peer-to-peer transaction request. For example, as shown in FIG. 2, the sender may receive a notification corresponding to the peer-to-peer application indicating that the recipient has added his/her account details and that the peer-to-peer transaction can be completed with the sender's authorization. The confirmation may include the recipient's name (e.g., parsed from the recipient's response to the recipient account details request or fetched from the account database) so that the sender may have an opportunity to verify that the correct sender received and responded to the recipient account details request. In the embodiment shown in FIG. 2, the sender may press an “approve” or similar authorizing button in screen 210 to authorize the system to complete the peer-to-peer transaction.

At block 114, the system may receive the authorization from the first device 202 to complete the peer-to-peer transaction. At block 116, in response to receiving the authorization from the first device 202 to complete the peer-to-peer transaction, the system may transfer funds in the transaction amount from the sender account to the recipient account. In some embodiments, the system may transfer funds to a service provider that holds the funds and makes them available for pickup at a physical location. The physical location may be a physical location that the recipient account is registered with the service provider to pick up funds or may be the physical location of a service provider to which the recipient has a relationship and entered in the response to the recipient account details request.

It is noted that the process 100 may be particularly useful in cross-border remittance use cases. In this regard, in some embodiments, when a sender has entered a phone number in the peer-to-peer transaction request at block 102, the system may analyze the phone number to determine the country to which the phone number corresponds. For example, the system may extract a country code from the phone number and search a lookup table using the country code to determine the corresponding country. Once the system has determined the country for the recipient phone number, the system may compare the country of the recipient to the country of the sender. For example, the system may fetch account information corresponding to the sender to determine the country to which the sender account corresponds. If the system determines that the country of the sender is different than the country of the recipient, the system may perform one or more processes described above at blocks 104-116 of FIG. 1 as the different determined country indicates that the sender intends to perform a cross-border remittance, which may require higher levels or stricter requirements for processing than remittances or transactions performed within the same country or region, for example, due to country-specific laws and regulations.

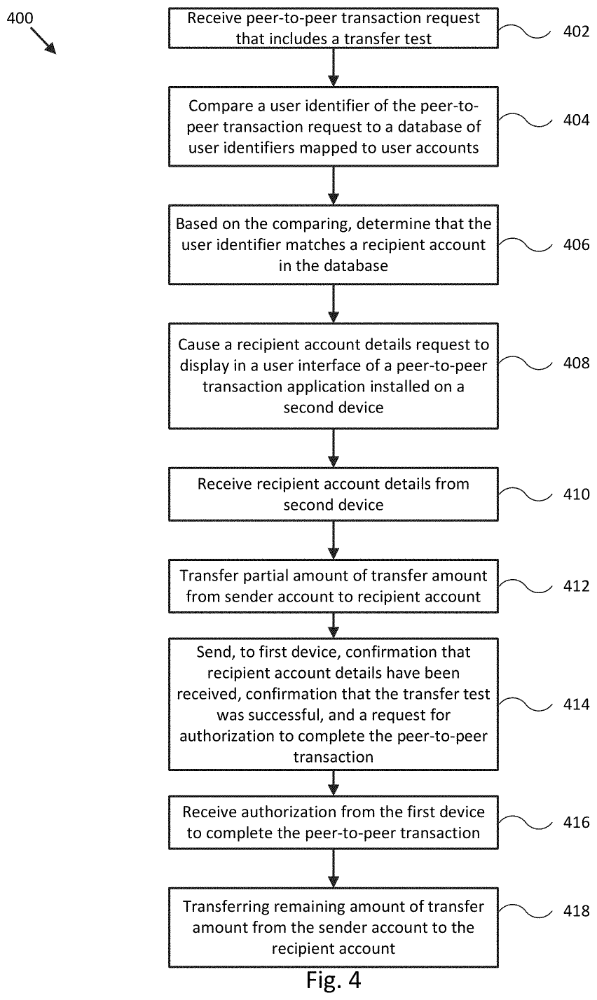

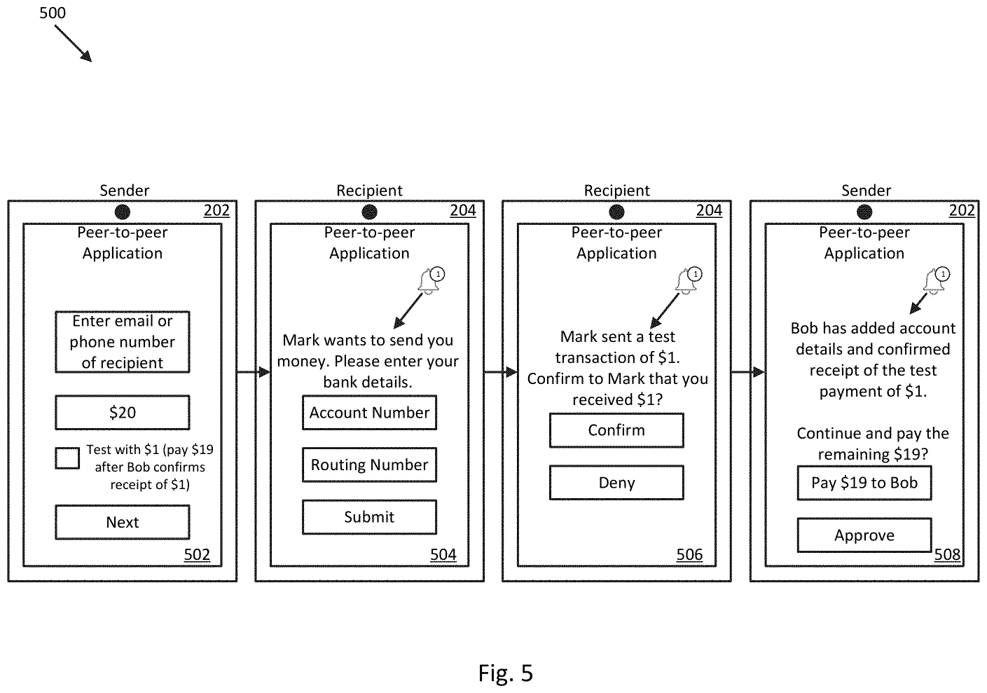

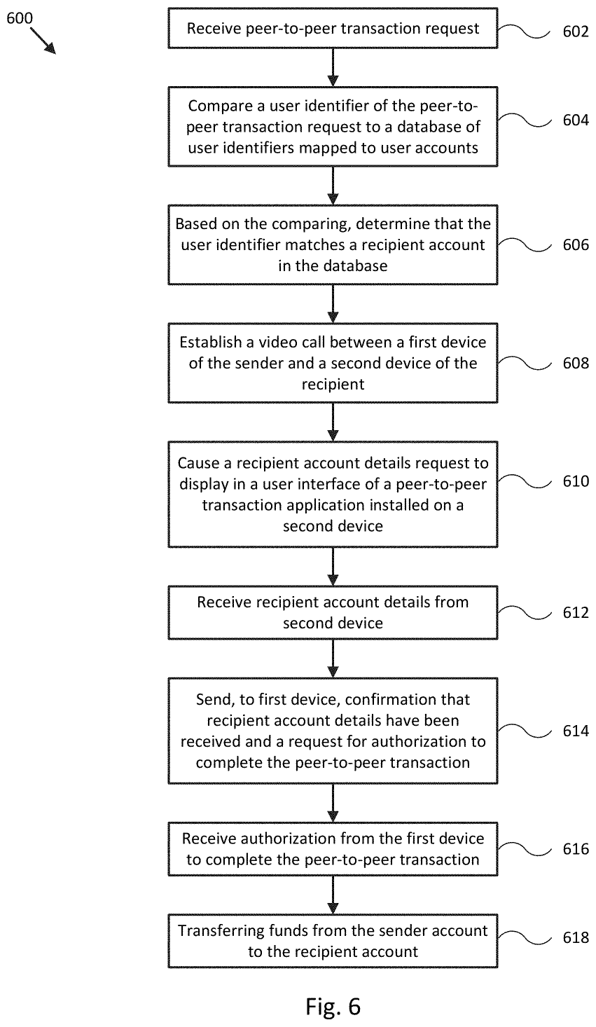

Referring now to FIG. 4, illustrated is a flow diagram of a process 400 for peer-to-peer transactions in accordance with one or more embodiments of the present disclosure. For explanatory purposes, process 400 is primarily described herein with reference to FIG. 5; however, the process 400 is not limited to FIG. 5 and may generally be applied consistent with process 100 and process 600 (described below with respect to FIG. 6) of the present disclosure. The blocks of process 400 are described herein as occurring in serial, or linearly (e.g., one after another). However, multiple blocks of process 400 may occur in parallel. In addition, the blocks of process 400 need not be performed in the order shown and/or one or more of the blocks of process 400 need not be performed.

At block 402, a system may receive, from a first device 202, a peer-to-peer transaction request associated with a sender account. The peer-to-peer transaction request may include a user identifier that has been entered by a sender in a user interface of a peer-to-peer transaction application installed on the first device 202. For example, as shown in the flow sequence 500 of FIG. 5, the sender may be presented with a prompt screen 502 displayed in the first device 202 that asks the sender to enter a user identifier such as an email address or phone number associated with the recipient. Other user identifiers such as social media handles may be used in some embodiments. In this regard, prompt screen 502 may be similar to the prompt screen 206 of FIG. 2. The prompt screen 502 may further ask the sender to enter a transaction amount for the peer-to-peer transaction. For illustrative purposes, FIG. 5 shows “$20” as a transaction amount that the sender has entered. The prompt screen 502 may include an option to perform a test transfer for an amount less than the full amount of the entered transaction amount. In some embodiments, a test transfer may allow the sender to verify that the recipient is able to receive the peer-to-peer transfer without requiring the sender to initially transfer a full amount. For example, the test transfer amount for twenty dollars may be one dollar. In some embodiments, the prompt screen 502 may include a fillable field for the sender to enter the desired test transfer amount. Once the sender has completed the fields in the prompt screen 502, the sender may submit the peer-to-peer transaction request to the system.

At block 404, the system may compare the user identifier included in the peer-to-peer transaction request to a database of user identifiers mapped to user accounts registered and/or stored to the database associated with and accessible by the system. In one embodiment, the comparing may include the system querying the database for the user identifier to determine the corresponding account. At block 406, based on the comparing, the system may determine that the user identifier matches a recipient account registered and/or stored to the database.

At block 408, in response to determining that the user identifier matches the recipient account registered and/or stored to the database, the system may cause a recipient account details request to display in a user interface of a peer-to-peer transaction application installed on a second device associated with the recipient account. For example, the recipient account may be logged into the peer-to-peer transaction application installed on the second device and, as shown in FIG. 5, the peer-to-peer transaction application may display a prompt screen 504 that notifies the recipient that a sender would like to transfer digital funds to the recipient account via the peer-to-peer transaction application. In some cases, the prompt screen 504 may be a pop-up notification associated with the peer-to-peer application that allows quick access (e.g., on a home screen or lock screen of the device) to fill out the recipient account details. In other cases, the prompt screen 504 may be displayed during the next time that the recipient opens the peer-to-peer transaction application on the second device 204. The prompt screen 504 may ask the recipient to enter account details that facilitate completing the peer-to-peer transaction. For example, as shown in FIG. 5, the prompt screen 504 may ask the recipient to enter an account number (e.g., a bank account number) and a routing number. Once the recipient has entered the requested information and pressed “Submit” or a similar button, the second device 204 may send the account information to the system.

In some embodiments, where the system determines that the user identifier does not match a recipient account in the database, the system may send the recipient account details request to the user identifier through a channel other than the peer-to-peer transaction application. For example, the user identifier may be an email address, phone number, or social media handle, and the system may send the recipient account details request to the email address through an email gateway, the phone number through an SMS gateway, or the social media handle through a social media messaging platform. The recipient account details request may include a hyperlink that when executed/pressed in an email, text, or social media application may open a peer-to-peer transaction web client (e.g., a web browser) of the second device 204, where the web client is in communication with a web application of the system. Through the peer-to-peer transaction web client, the recipient may input his/her account details in a web user interface having a prompt screen similar to the prompt screen 504 shown in FIG. 5. For example, the prompt screen in the web client may ask the recipient to enter account details such as a bank account number and routing number to facilitate completing the peer-to-peer transaction. The recipient may enter the requested information and press “Submit” or a similar button, and the web client of the second device 204 may send the account information to the system through network communications with the web application.

Referring back to FIG. 4, at block 410, the system may receive the account details from the second device 204. At block 412, in response to receiving the account details from the second device 204, the system may transfer less than a full amount of the transaction from the sender account to the recipient account per the request for the transfer test made by the sender. After the transfer test has been completed, the system may cause prompt screen 506 to display in the second device 204 user interface to notify the recipient that the transfer test has been performed. The recipient may confirm or deny that the test transaction was successfully completed. If the system receives a confirmation from the second device 204 that the test transfer was confirmed to be completed, the system may proceed to block 414. At block 414, the system may send, to the first device 202, a confirmation that the recipient account details were received from the second device 204, a confirmation that the transfer test was successful, and a request for an authorization to complete the peer-to-peer transaction request. For example, as shown in FIG. 5, the sender may receive a notification corresponding to the peer-to-peer application indicating that the recipient has added his/her account details and confirmed that the test transfer was successful. The peer-to-peer transaction can be completed with the sender's authorization at screen 508. In the embodiment shown in FIG. 5, the sender may press an “approve” or similar authorizing button in screen 508 to authorize the system to complete the peer-to-peer transaction by transferring the remaining portion of the transaction amount.

At block 416, the system may receive the authorization from the first device 202 to complete the peer-to-peer transaction. At block 418, in response to receiving the authorization from the first device 202 to complete the peer-to-peer transaction, the system may transfer the remaining portion of the transaction amount from the sender account to the recipient account.

FIG. 6 illustrates a flow diagram of a process 600 for peer-to-peer transactions using video calls in accordance with one or more embodiments of the present disclosure. For explanatory purposes, process 600 is primarily described herein with reference to FIGS. 2, 5, and 7; however, the process 600 is not limited to FIGS. 2, 5, and 7 and may generally be applied consistent with process 100 and process 400 and the remaining figures of the present disclosure. The blocks of process 600 are described herein as occurring in serial, or linearly (e.g., one after another). However, multiple blocks of process 600 may occur in parallel. In addition, the blocks of process 600 need not be performed in the order shown and/or one or more of the blocks of process 600 need not be performed.

At block 602, a system may receive, from a first device 202, a peer-to-peer transaction request associated with a sender account. The peer-to-peer transaction request may include a user identifier that has been entered by a sender in a user interface of a peer-to-peer transaction application installed on the first device. For example, as shown in the flow sequence 200 of FIG. 2, the sender may be presented with a prompt screen 206 of a user interface of a peer-to-peer transaction application installed in the first device 202 that asks the sender to enter a user identifier such as an email address or phone number associated with the recipient. As another example, as shown in the flow sequence 500 of FIG. 5, the sender may be presented with a prompt screen 502 of a user interface of a peer-to-peer transaction application installed in the first device 202 that asks the sender to enter a user identifier and select whether to perform a test transaction. Other user identifiers such as social media handles may be used in some embodiments as discussed herein. A prompt screen in the user interface may further ask the sender to enter a transaction amount for the peer-to-peer transaction.

At block 604, the system may compare the user identifier included in the peer-to-peer transaction request to a database of user identifiers mapped to user accounts registered and/or stored to the database of the system. In one embodiment, the comparing may include the system querying the database for the user identifier to determine the corresponding account. At block 606, based on the comparing, the system may determine that the user identifier matches a recipient account registered and/or stored to the database.

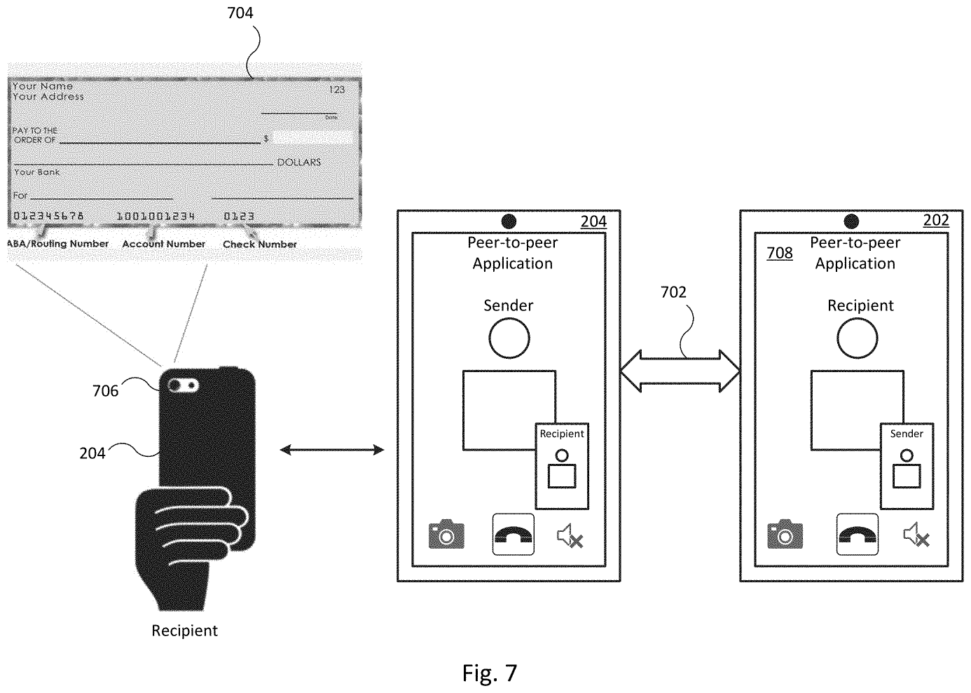

At block 608, in response to determining that the user identifier matches the recipient account registered and/or stored to the database, the system may establish a video call 702 (shown in FIG. 7) between the first device 202 and the second device 204 (e.g., via the internet and/or cellular data). At block 610, the system may cause a recipient account details request to display in the user interface of the second device 204 during the video call 702. The recipient account details request may include instructions for the recipient to capture an image of recipient account details so that the system may extract the recipient account details from the captured image. For example, a camera 706 of the second device 204 may be used to capture the recipient account details from a check 704 as a still image or as an image frame(s) of a video during the video call 702. The recipient account details may include contact information (e.g., name, address), an account number (e.g., bank account number), and a routing number according to some embodiments.

In some embodiments, the system may cause the user interface of the first device 202 to blur while the recipient is capturing the recipient account details during the video call 702. For example, to protect the sensitive data that the recipient is capturing during the video call 702 using the camera 706 of the second device 204, the video call screen 708 on the first device of the sender may blur until the recipient account details have been captured. For example, the system may be blur the screen 708 for the first device 202 as soon as the recipient indicates that they have read the user instructions to capture the recipient account details and begins capturing the recipient account details until the system detects that the recipient has finished capturing the recipient account details in the image.

Referring back to FIG. 6, at block 612, the recipient account details in the captured image may be sent from the second device 204 to the system for extraction of the recipient account details from the captured image. In some embodiments, the system may perform a character recognition algorithm over the captured image to extract the recipient account details. The template method, indicative method, structural recognition method, and/or an artificial neural network may be implemented in various embodiments to perform the character recognition.

In some embodiments, where the system determines that the user identifier does not match a recipient account in the database, the system may send the recipient account details request to the user identifier through a communication channel associated with the user identifier. For example, the user identifier may be an email address, phone number, or social media handle, and the system may send the recipient account details request to the email address through an email gateway, the phone number through an SMS gateway, or to the social media handle through a social media messaging platform. The recipient account details request may include a hyperlink that when executed/pressed may open a peer-to-peer transaction web client (e.g., a web browser) of the second device 204, where the web client is in communication with a web application of the system. In some embodiments, the peer-to-peer transaction web client may request permission to use a camera of the second device 204 to establish a video call 702. The recipient may provide permission and input his/her account details during the video call as described above.

At block 614, after the system has extracted the recipient account details from the captured image, the system may send, to the first device 202, a confirmation of the recipient account details received from the second device and a request for an authorization to complete the peer-to-peer transaction request. For example, as shown in FIG. 2, the sender may receive a notification corresponding to the peer-to-peer application indicating that the recipient has added his/her account details and that the peer-to-peer transaction can be completed with the sender's authorization. As shown in FIG. 2, the sender may press an “approve” button in screen 210 to authorize the system to complete the peer-to-peer transaction. At block 616, the system may receive the authorization from the first device 202 to complete the peer-to-peer transaction. At block 618, in response to receiving the authorization from the first device 202 to complete the peer-to-peer transaction, the system may transfer funds from the sender account to the recipient account.

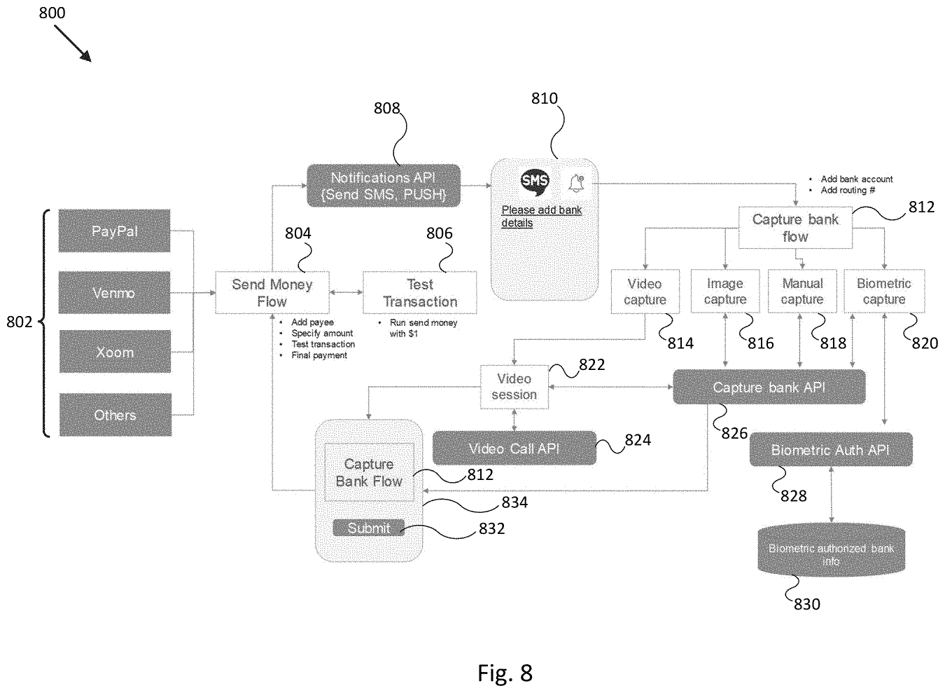

FIG. 8 illustrates a flow diagram 800 for implementing the processes 100, 400, and 600 into operation of a peer-to-peer transaction system in accordance with one or more embodiments of the present disclosure. In the embodiment shown in FIG. 8, peer-to-peer transaction service providers systems 802 may initiate a peer-to-peer transaction using a send money flow 804. The send money flow 804 may include obtaining information from the sender to perform the peer-to-peer transaction, such information may include a user identifier (e.g., email address, phone number, social media handle, etc.), transaction amount, whether the sender wants to execute a test transaction 806 (e.g., transfer test) and how much to use for the test transaction 806, whether the sender wants to establish a video call session 822 to authenticate the recipient and extract recipient account details, and what, if any, authentication challenge(s) to include in a recipient account details request.

The systems 802 may use various Application Programming Interfaces (APIs) to perform one or more functions discussed in the present disclosure. The system 802 may use a notifications API 808 to send a recipient account details request 810 to the device associated with the intended recipient. As discussed herein, the recipient account details request 810 may include a push notification associated with a peer-to-peer transaction application installed on the device associated with the intended recipient. In some cases, the system 802 may determine that the peer-to-peer transaction application is not currently installed on the device associate with the recipient and may send a text message or email to the user identifier entered by the sender where the text message or emails may contain a link to a website capable of performing the peer-to-peer transaction application via a web interface.

The recipient account details may be captured by the system during a capture bank flow 812. The recipient account details may be captured in various ways such as through video capture 814, image capture 816, manual capture 818, and/or biometric capture 820. The capture bank flow 812 may be a sub-flow of the send money flow 804 and may include using a capture bank API 826 to capture recipient account details in various ways. For example, in the capture bank flow 812, the system may capture the recipient account details through video capture 814 such as during a video call session 822 established using video call API 824. The recipient may use a camera of his/her device to capture a video of the recipient account details such as on a check.

The capture bank flow 812 may also include an image capture 816 such as when the recipient, to respond to the recipient account details request, captures a still image of the recipient account details such as on a check using his/her device's camera.

The capture flow bank 812 may also include a manual capture 818 in which the recipient may manually enter his/her account details to complete the recipient account details request.

The capture flow bank 812 may also include a biometric capture 820 in which the recipient may complete a biometric authentication challenge to automatically respond to and complete the recipient account details request. In cases where the recipient completes the biometric authentication challenge, the system may use a biometric authentication API 828 to authenticate the user and upon authentication, obtain the recipient account details from a biometric authorized bank info 830 (e.g., an information database). Once the account details have been captured, the system 802 may provide to the recipient's device a confirmation screen 834 where the recipient may press a “Submit” button 832 to complete the send money flow 804 and have funds transferred from a sender account to a recipient account.

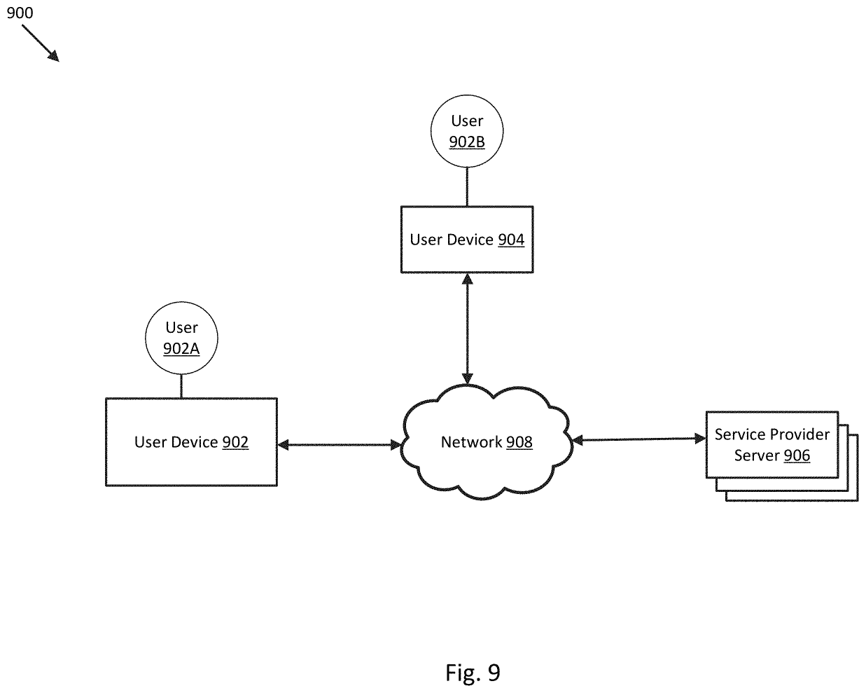

Referring now to FIG. 9, a block diagram of a networked system 900 configured to reduce peer-to-peer transaction detail errors in accordance with one or more embodiments of the present disclosure is illustrated. System 900 includes a user device 902, a user device 904, and a peer-to-peer service provider server(s) 906. A user 902A is associated with user device 902, where user 902A can provide an input to service provider server 906 using user device 902. A user 902B is associated with user device 904, where user 902B can provide an input to service provider server 906 using user device 902B. User 902A and user 902B may perform peer-to-peer transactions in accordance with embodiments of the present disclosure.

User device 902, user device 904, and service provider server 906 may each include one or more processors, memories, and other appropriate components for executing instructions such as program code and/or data stored on one or more computer-readable mediums to implement the various applications, data, and steps described herein. For example, such instructions may be stored in one or more computer-readable media such as memories or data storage devices internal and/or external to various components of system 900, and/or accessible over a network 908. Each of the memories may be non-transitory memory. Network 908 may be implemented as a single network or a combination of multiple networks. For example, in various embodiments, network 908 may include the Internet or one or more intranets, landline networks, and/or other appropriate types of networks.

User device 902 may be implemented using any appropriate hardware and software configured for wired and/or wireless communication over network 908. For example, in some embodiments, user device 902 may be implemented as a personal computer (PC), a mobile phone, personal digital assistant (PDA), laptop computer, and/or other types of computing devices capable of transmitting and/or receiving data, such as an iPhone™, Watch™, or iPad™ from Apple™.

User device 902 may include one or more browser applications which may be used, for example, to provide a convenient interface to facilitate responding to recipient account detail requests over network 908. For example, in one embodiment, the browser application may be implemented as a web browser configured to view information available over the internet and respond to requests sent by service provider server 906. User device 902 may also include one or more toolbar applications which may be used, for example, to provide client-side processing for performing desired tasks in response to operations selected by user 902A. In one embodiment, the toolbar application may display a user interface in connection with the browser application.

User device 902 may further include other applications as may be desired in particular embodiments to provide desired features to user device 902. For example, the other applications may include an application to interface between service provider server 906 and the network 908, security applications for implementing client-side security features, programming client applications for interfacing with appropriate application programming interfaces (APIs) over network 908, or other types of applications. In some cases, the APIs may correspond to service provider server 906. The applications may also include email, texting, voice, and instant messaging applications that allow user 902A to send and receive emails, calls, and texts through network 908, as well as applications that enable the user to communicate to service provider server 906 as discussed above. User device 902 includes one or more device identifiers which may be implemented, for example, as operating system registry entries, cookies associated with the browser application, identifiers associated with hardware of user device 902, or other appropriate identifiers, such as those used for user, payment, device, location, and or time authentication. In some embodiments, a device identifier may be used by service provider server 906 to associate user 902A with a particular account maintained by the service provider server 906. A communications application with associated interfaces facilitates communication between user device 902 and other components within system 900. User device 904 may be similar to user device 902.

Service provider server 906 may be maintained, for example, by an online service provider which may provide peer-to-peer transaction services. In this regard, service provider server 906 includes one or more peer-to-peer applications which may be configured to interact with user device 902 and user device 904 over network 908 to facilitate the peer-to-peer transaction services, including transaction detail error reduction as discussed in the present disclosure. Service provider server 906 maintains a plurality of user accounts (e.g., stored in a user account database accessible by service provider server 906), each of which may include account information associated with individual users. Service provider server 906 may communicate over network 908 with a payment network and/or other network servers capable a transferring funds between financial institutions and other third-party providers to complete peer-to-peer transaction requests.

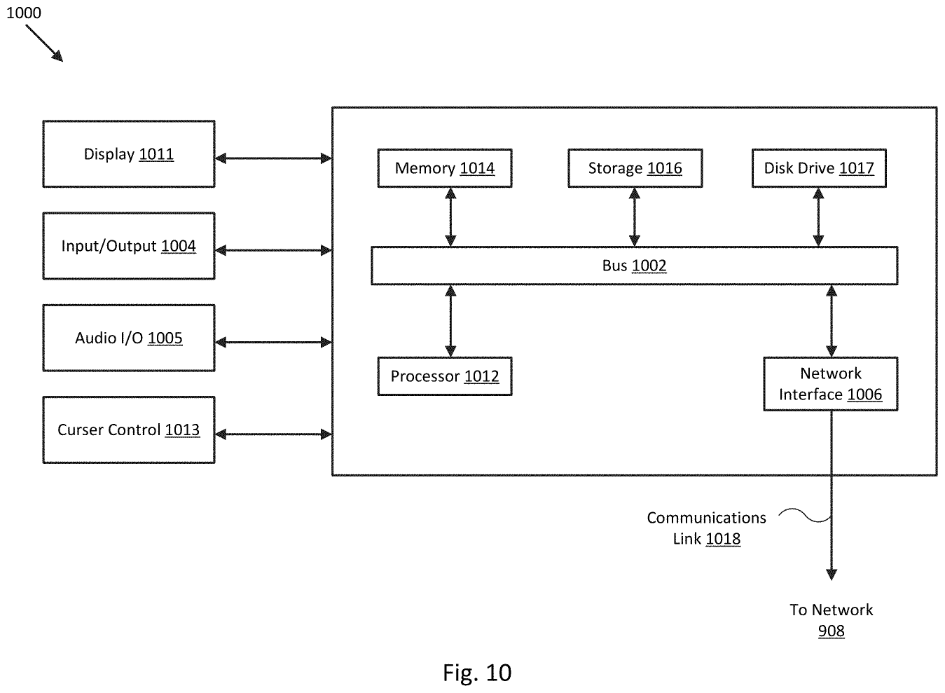

FIG. 10 illustrates a block diagram of a computer system 1000 suitable for implementing one or more embodiments of the present disclosure. In various implementations, a user device may comprise a personal computing device (e.g., a personal computer, laptop, smart phone, PDA, Bluetooth device, key FOB, badge, etc.) capable of communicating with the network. It should be appreciated that each of the devices utilized by users, entities, and service providers, and payment networks discussed herein may be implemented as computer system 1000 in a manner as follows.

Computer system 1000 includes a bus 1002 or other communication mechanism for communicating information data, signals, and information between various components of computer system 1000. Components include an input/output (I/O) component 1004 that processes a user action, such as selecting keys from a keypad/keyboard, selecting one or more buttons or links, etc., and sends a corresponding signal to bus 1002. I/O component 1004 may also include an output component, such as a display 1011 and a cursor control 1013 (such as a keyboard, keypad, mouse, etc.). I/O component 1004 may further include NFC communication capabilities. An optional audio I/O component 1005 may also be included to allow a user to use voice for inputting information by converting audio signals. Audio I/O component 1005 may allow the user to hear audio. A transceiver or network interface 1006 transmits and receives signals between computer system 1000 and other devices, such as another user device, an entity server, and/or a provider server via network 908. In one embodiment, the transmission is wireless, although other transmission mediums and methods may also be suitable. Processor 1012, which may be one or more hardware processors, can be a micro-controller, digital signal processor (DSP), or other processing component, processes these various signals, such as for display on computer system 1000 or transmission to other devices via a communication link 1018. Processor 1012 may also control transmission of information, such as cookies or IP addresses, to other devices.

Components of computer system 1000 also include a system memory component 1014 (e.g., RAM), a static storage component 1016 (e.g., ROM), and/or a disk drive 1017. Computer system 1000 performs specific operations by processor 1012 and other components by executing one or more sequences of instructions contained in system memory component 1014. Logic may be encoded in a computer-readable medium, which may refer to any medium that participates in providing instructions to processor 1012 for execution. Such a medium may take many forms, including but not limited to, non-volatile media, volatile media, and transmission media. In various implementations, non-volatile media includes optical or magnetic disks, volatile media includes dynamic memory, such as system memory component 1014, and transmission media includes coaxial cables, copper wire, and fiber optics, including wires that comprise bus 1002. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 1000. In various other embodiments of the present disclosure, a plurality of computer systems 1000 coupled by communication link 1018 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure.

What is claimed is:

1. A system, comprising:
a non-transitory memory; and
one or more hardware processors coupled to the non-transitory memory and configured to read instructions from the non-transitory memory to cause the system to perform operations comprising:
receiving, from a first device, a peer-to-peer transaction request associated with a sender account, wherein the peer-to-peer transaction request includes a user identifier;
comparing the user identifier to a database of user identifiers mapped to user accounts;
based on the comparing, determining that the user identifier matches a recipient account in the database;
causing a recipient account details request to display in a user interface of a peer-to-peer transaction application installed on a second device, wherein the recipient account is logged into the peer-to-peer transaction application installed on the second device;
receiving, from the second device, recipient account details;
sending to the first device a confirmation of the recipient account details received from the second device and a request for an authorization to complete the peer-to-peer transaction request;
receiving the authorization from the first device to complete the peer-to-peer transaction request; and
in response to receiving the authorization from the first device to complete the peer-to-peer transaction request, transferring funds from the sender account to the recipient account.

2. The system of claim 1, wherein:
the peer-to-peer transaction request includes a request for a transfer test;
the operations further comprise in response to receiving, from the second device, recipient account details, transferring less than a full amount of the funds from the sender account to the recipient account per the request for the transfer test; and
the request for authorization to complete the peer-to-peer transaction request indicates a successful transfer of the less than the full amount of the funds from the sender account to the recipient account.

3. The system of claim 1, wherein the recipient account details include a bank account number and a routing number.

4. The system of claim 1, wherein the user identifier comprises an email address.

5. The system of claim 1, wherein:
the user identifier comprises a phone number;
the operations further comprise determining that a country calling code of the phone number is different than a country calling code corresponding to the sender account; and
the causing the recipient account details request to display in the user interface of the peer-to-peer transaction application installed on the second device is in response to the determining that the country calling code of the phone number is different than the country calling code corresponding to the sender account.

6. The system of claim 1, wherein:
the operations further comprise establishing a video call between a peer-to-peer transaction application installed on the first device and the peer-to-peer transaction application installed on the second device; and
the recipient account details request is displayed during the video call and has user instructions to capture an image of the recipient account details to extract the recipient account details from the captured image.

7. The system of claim 6, wherein the operations further comprise causing a user interface of the peer-to-peer application installed on the first device to blur during the capture of the image of the recipient account details.

8. The system of claim 1, wherein the recipient account details request includes a biometric authentication challenge that, upon successful completion, causes the recipient account details to be automatically populated in text fields of the recipient account details request.

9. A method comprising:
receiving, from a first device, a peer-to-peer transaction request associated with a sender account, wherein the peer-to-peer transaction request includes a user identifier;
comparing the user identifier to user identifiers corresponding to user accounts;
based on the comparing, determining that the user identifier does not match a recipient account from the user accounts;
sending a recipient account details request to the user identifier, wherein the recipient account details request includes a hyperlink to a user interface of a peer-to-peer transaction application available via a web browser installed on a second device;
receiving, from the second device and through the user interface of the peer-to-peer transaction application executing via the web browser, recipient account details associated with a recipient account;
sending to the first device a confirmation of the recipient account details received from the second device and a request for an authorization to complete the peer-to-peer transaction request;
receiving the authorization from the first device to complete the peer-to-peer transaction request; and
in response to receiving the authorization from the first device to complete the peer-to-peer transaction request, transferring funds from the sender account to the recipient account.

10. The method of claim 9, wherein:
the peer-to-peer transaction request includes a request for a transfer test;
the method further comprises in response to receiving, from the second device, recipient account details, transferring less than a full amount of the funds from the sender account to the recipient account per the request for the transfer test; and
the request for authorization to complete the peer-to-peer transaction request indicates a successful transfer of the less than the full amount of the funds from the sender account to the recipient account.

11. The method of claim 9, wherein:
the user identifier comprises a phone number;
the method further comprises determining that a country calling code of the phone number is different than a country calling code corresponding to the sender account; and
the causing the recipient account details request to display in the user interface of the peer-to-peer transaction application installed on the second device is in response to the determining that the country calling code of the phone number is different than the country calling code corresponding to the sender account.

12. The method of claim 9, further comprising:
establishing a video call between a peer-to-peer transaction application installed on the first device and the peer-to-peer transaction application executing via the web browser installed on the second device; and
the recipient account details request is displayed during the video call and has user instructions to capture an image of the recipient account details to extract the recipient account details from the captured image.

13. The method of claim 12, further comprising causing a user interface of the peer-to-peer application installed on the first device to blur during the capture of the image of the recipient account details.

14. The method of claim 9, wherein the recipient account details request includes a biometric authentication challenge that, upon a successful completion, causes the recipient account details to be automatically populated in text fields of the recipient account details request.

15. A non-transitory machine-readable medium having stored thereon machine-readable instructions executable to cause a machine to perform operations comprising:
receiving, from a first device, a peer-to-peer transaction request associated with a sender account, wherein the peer-to-peer transaction request includes a user identifier;
comparing the user identifier to stored user identifiers corresponding to user accounts;
based on the comparing, determining that the user identifier matches a recipient account of the user accounts;
causing a recipient account details request to display in a user interface of a peer-to-peer transaction application installed on a second device, wherein the recipient account is logged into the peer-to-peer transaction application installed on the second device;
receiving, from the second device, recipient account details;
sending to the first device a confirmation of the recipient account details received from the second device;
sending to the first device a request for an authorization to complete the peer-to-peer transaction request;
receiving the authorization from the first device to complete the peer-to-peer transaction request; and
in response to receiving the authorization from the first device to complete the peer-to-peer transaction request, causing funds to transfer from the sender account to the recipient account.

16. The non-transitory machine-readable medium of claim 15, wherein
the peer-to-peer transaction request includes a request for a transfer test;
the operations further comprise in response to receiving, from the second device, recipient account details, transferring less than a full amount of the funds from the sender account to the recipient account per the request for the transfer test; and
the request for authorization to complete the peer-to-peer transaction request indicates a successful transfer of the less than the full amount of the funds from the sender account to the recipient account.

17. The non-transitory machine-readable medium of claim 15, wherein the recipient account details include a bank account number and a routing number.

18. The non-transitory machine-readable medium of claim 15, wherein:
the user identifier comprises a phone number;
the operations further comprise determining that a country calling code of the phone number is different than a country calling code corresponding to the sender account; and
the causing the recipient account details request to display in the user interface of the peer-to-peer transaction application installed on the second device is in response to the determining that the country calling code of the phone number is different than the country calling code corresponding to the sender account.

19. The non-transitory machine-readable medium of claim 15, wherein:
the operations further comprise establishing a video call between a peer-to-peer transaction application installed on the first device and the peer-to-peer transaction application installed on the second device; and
the recipient account details request is displayed during the video call and has user instructions to capture an image of the recipient account details to extract the recipient account details from the captured image.

20. The non-transitory machine-readable medium of claim 19, wherein the operations further comprise causing a user interface of the peer-to-peer application installed on the first device to blur during the capture of the image of the recipient account details.
